(19) United States
(12) Patent Application Publication
(10) Pub. No.: US 2026/0329219 A1
(43) Pub. Date: Oct. 22, 2026

(54) SHEET-ATTITUDE CONTROL APPARATUS AND IMAGE FORMING SYSTEM

(71) Applicants: Haruo HASHIMOTO, Kanagawa (JP); Masashi SATO, Kanagawa (JP)

(72) Inventors: Haruo HASHIMOTO, Kanagawa (JP); Masashi SATO, Kanagawa (JP)

(73) Assignee: Ricoh Company, Ltd., Tokyo (JP)

(21) Appl. No.: 19/648,576

(22) Filed: Apr. 15, 2026

(30) Foreign Application Priority Data
Apr. 22, 2025 (JP) 2025-070795

(51) Int. Cl. G03G 15/00; G03G 15/01

(52) U.S. Cl. CPC G03G 15/6573; G03G 15/0142; G03G 15/6567; G03G 2215/00405; G03G 2215/00417; G03G 2215/0054; G03G 2215/00565

(57) ABSTRACT

A sheet-attitude control apparatus includes: a main body; a conveyance path, passing through the main body, along which a sheet is conveyed in a conveyance direction; a first side face of the main body in the conveyance direction, the first side face facing an image forming apparatus to form an image on the sheet fed from the main body; a second side face of the main body downstream of the first side face in the conveyance direction, the second side face facing a sheet feeder to load the sheet to be fed to the main body; and a first engagement portion at the first side face, and the first engagement portion having a first pair of pins to be respectively inserted into a pair of holes in the image forming apparatus.

### CROSS-REFERENCE TO RELATED APPLICATIONS

This patent application is based on and claims priority pursuant to 35 U.S.C. § 119(a) to Japanese Patent Application No. 2025-070795, filed on Apr. 22, 2025, in the Japan Patent Office, the entire disclosure of which is hereby incorporated by reference herein.

### BACKGROUND

### Technical Field

The present disclosure relates to a sheet-attitude control apparatus to be attached to an image forming apparatus and an image forming system.

### Related Art

An image forming apparatus has upstream and downstream sides in a sheet conveyance direction to which optional units including a preprocessing apparatus, such as a sheet load unit, and a post-processing machine, such as a sheet folding machine, are coupled, thereby supporting high-volume printing.

When an image forming apparatus, as described above, is coupled to an optional unit, the difference in height between the image forming apparatus and the optional unit is adjusted. For example, bolts are used to adjust the heights of the image forming apparatus and the optional unit, after which the optional unit is positioned.

In such a configuration, the height of the image forming apparatus is fixed to adjust the height of the optional unit, and to position the optional unit. However, after the heights of the image forming apparatus and the optional unit have been fixed, there are cases where a sheet is skewed or an image is incorrectly printed on the sheet during an image forming operation. In such cases, a procedure may be taken to readjust the height of the optional unit.

Adjusting the heights of the image forming apparatus and the optional unit, for example, with adjusters after the installation may involve significant amounts of time and effort.

To shorten installation time, a method for easily adjusting the difference in height between an image forming apparatus and an optional unit is desired.

### SUMMARY

The present disclosure described herein provides a sheet-attitude control apparatus including: a main body; a conveyance path, passing through the main body, along which a sheet is conveyed in a conveyance direction; a first side face of the main body in the conveyance direction, the first side face facing an image forming apparatus to form an image on the sheet fed from the main body; a second side face of the main body downstream of the first side face in the conveyance direction, the second side face facing a sheet feeder to load the sheet to be fed to the main body; a first engagement portion at the first side face, the first engagement portion having a first pair of pins to be respectively inserted into a pair of holes in the image forming apparatus, the first pair of pins disposed at a first height and at different positions in a width direction perpendicular to the conveyance direction; a first fastening portion at a second height different from the first height to fasten the main body and the image forming apparatus; a second engagement portion at the first side face, the second engagement portion having a second-pair of pins to be respectively inserted into a pair of holes in the sheet feeder, the second pair of pins disposed at a third height and at different positions in the width direction; a second fastening portion at a fourth height different from the third height to fasten the main body and the sheet feeder; wherein the main body coupled to the image forming apparatus and the sheet feeder has a lowest bottom face spaced apart from an installation surface of the image forming apparatus and the sheet feeder.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view of a configuration example of an image forming apparatus;

FIG. 2 is a front view of an overall configuration example of an image forming system including the image forming apparatus;

FIG. 3 is a top view of the overall configuration example of the image forming system including the image forming apparatus;

FIG. 4 is a view of a configuration example of a sheet-attitude control apparatus of a comparative example;

FIGS. 5A and 5B are views of a positioning configuration example of the sheet-attitude control apparatus illustrated in FIG. 4;

FIG. 6 is a cross-sectional view of an example of the positioning configuration illustrated in FIG. 2 as viewed from the connection surface side;

FIG. 7 is a cross-sectional view of an example of the positioning configuration illustrated in FIG. 3 as viewed from the front side;

FIG. 8 is a cross-sectional view of an example of a positioning configuration illustrated in FIG. 2 as viewed from the connection surface side;

FIG. 9 is a cross-sectional view of an example of the positioning configuration illustrated in FIG. 3 as viewed from the front side;

FIG. 10 is a view of an example of a method for attaching the sheet-attitude control apparatus to the image forming apparatus;

FIG. 11 is a view of the positional relationship in the configuration illustrated in FIG. 10 during the attachment;

FIG. 12 is a view of an example of a method for attaching the sheet feeder to the sheet-attitude control apparatus; and

FIG. 13 is a view of another example of the positional relationship in the configuration illustrated in FIG. 12 during the attachment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

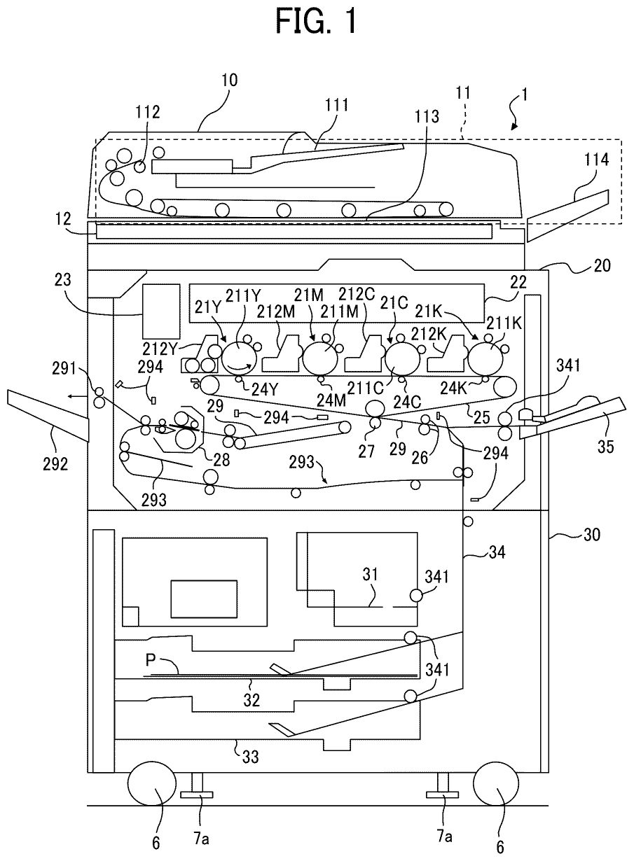

FIG. 1 illustrates a schematic configuration of an image forming apparatus 1.

The image forming apparatus 1 is a multifunction printer (MFP) having a printer function and a copying function to form images on sheets P, which are sheet-shaped recording media. The image forming apparatus 1 includes: a document reader 10 provided in an upper portion of the image forming apparatus 1; an apparatus main body 20 including an image forming unit that forms images on the sheets P; and a sheet storage unit 30 that stores the sheets P.

The document reader 10 includes a document conveyor 11 and a reading device 12.

The document conveyor 11 includes: a document tray 111; a document conveyance path 112 along which a document on the document tray 111 is to be conveyed; a platen 113 that holds a document to be conveyed; and a document discharge tray 114.

The document conveyor 11 conveys a document placed on the document tray 111 to the document discharge tray 114 along the document conveyance path 112 via the platen 113 formed of a transparent plate.

The reading device 12, which is disposed below the platen 113, optically reads an image from a document being conveyed over the platen 113 and creates image data representing the image on the document.

The created image data is transmitted as data to a controller 23 that will be described later and will be used for electrostatic latent images of respective colors to be created by an optical writer 22.

The sheet storage unit 30 includes: a plurality of storage trays 31, 32, and 33 each of which stores sheets P, which are sheet-shaped recording media; and a take-out conveyance path 34 along which the sheets P are to be conveyed from each of the storage trays 31, 32, and 33.

In the present embodiment, the storage trays 31, 32, and 33 can contain differently-sized sheets P. The sheets P on the storage trays 31, 32, and 33 are taken out one by one by pickup rollers 341 in the take-out conveyance path 34 and conveyed along the take-out conveyance path 34.

The apparatus main body 20 functions as an image forming unit that forms full-color images by using toners of the four colors: yellow Y, magenta M, cyan C, and black K.

The apparatus main body 20 includes: image forming units 21Y, 21M, 21C, and 21K for the respective four colors: Y, M, C, and K; the optical writer 22; the controller 23 that controls individual units in the image forming apparatus 1; primary transfer rollers 24Y, 24M, 24C, and 24K corresponding to the respective colors; an intermediate transfer belt 25, which is an endless transfer body; a registration roller 26, and secondary transfer roller 27.

In addition, the apparatus main body 20 includes: a fixing device 28 that applies heat and pressure to a sheet P to fix the toner image on the sheet P; and sheet conveyance paths 29 along which the sheet P is to be moved.

Furthermore, as parts constituting the sheet conveyance paths 29, the apparatus main body 20 includes: a sheet discharge roller 291 attached to a side of the apparatus main body 20; a sheet discharge tray 292 disposed downstream of the sheet discharge roller 291; and a sheet reverse path 293 along which the sheet P is to be transferred from the downstream side of the fixing device 28 to the upstream side of the registration roller 26.

The sheet conveyance path 29 is provided with a plurality of sheet sensors 294 at predetermined locations to detect the presence of the sheet P at target locations. With such a configuration, the presence of the sheet P is detected by the sheet sensors 294. Thus, even if the sheet P jams, the cause and place of the paper jam can be easily identified.

In FIG. 1, for example, some sheet sensors 294 are disposed at a location downstream of a pickup roller 341 of a manual sheet feeding tray 35, at a location of the inlet through which the sheets P are to be passed from the sheet storage unit 30, and at a location upstream of the registration roller 26.

Moreover, other sheet sensors 294 are provided downstream of the secondary transfer roller 27, upstream and downstream of the fixing device 28, and upstream of the sheet discharge roller 291.

The image forming units 21Y, 21M, 21C, and 21K include: corresponding photoconductor drums 211Y, 211M, 211C, and 211K; and developing units 212Y, 212M, 212C, and 212K, respectively.

The photoconductor drums 211Y, 211M, 211C, and 211K rotate counterclockwise in the drawing, so that electrostatic latent images are written on the rotating photoconductor drums 211Y, 211M, 211C, and 211K by scanning exposure from the optical writer 22.

Then, the developing units 212Y, 212M, 212C, and 212K develop toner images of respective colors in accordance with the electrostatic latent images drawn on the photoconductor drums 211Y, 211M, 211C, and 211K.

The developed toner images of the respective colors are primarily transferred onto the intermediate transfer belt 25 so as to overlap each other by the primary transfer rollers 24Y, 24M, 24C, and 24K. As a result, the toner images of the respective colors are superimposed on the intermediate transfer belt 25 to form a full-color image.

When the toner image is conveyed to the secondary transfer roller 27 in conjunction with the movement of the intermediate transfer belt 25, the toner image is secondarily transferred onto the sheet P conveyed from the sheet storage unit 30 or the manual sheet feeding tray 35.

The registration roller 26 is a member that temporarily holds the sheet P conveyed in the above manner in front of the secondary transfer roller 27 and then feeds the sheet P in accordance with the timing at which the toner image on the intermediate transfer belt 25 reaches the secondary transfer roller 27.

After having been transferred from the intermediate transfer belt 25 to the sheet P at the secondary transfer roller 27, the toner image is moved along the sheet conveyance path 29 while adhering to the sheet P and then is fixed on the sheet P by heat and pressure applied by the fixing device 28.

If an image is formed on one side of the sheet P, the sheet P is passed through the fixing device 28, is further passed along the sheet conveyance path 29, and is discharged from the sheet discharge roller 291 to the sheet discharge tray 292.

The image forming apparatus 1 illustrated in FIG. 1 can form toner images on both sides of the sheet P. When image formation on both sides is selected, a toner image is formed on one side, after which the sheet P is passed through the fixing device 28 and then conveyed to the sheet reverse path 293.

In the sheet reverse path 293, the front and back sides of the sheet P are reversed and transferred to the upstream side of the registration roller 26.

The controller 23 is a computer including a central processing unit (CPU), a main memory (MEM-P), a north bridge (NB), a south bridge (SB), and some other units.

In addition, the controller 23 includes an accelerated graphics port (AGP) bus, an application specific integrated circuit (ASIC), and a local memory (MEM-C).

Furthermore, the controller 23 includes a hard disk (HD), a hard disk drive (HDD), a peripheral component interconnect (PCI) bus, and a network interface (I/F).

The CPU processes and calculates data and controls the operations of the above units, in accordance with programs stored in the main memory. The main memory serves as a storage area of the controller 23 and stores programs and data for use in implementing each function of the controller 23. Alternatively, the programs may be recorded in a computer-readable recording medium, such as a compact disc read only memory (CD-ROM), a flexible disk (FD), a compact disc recordable (CD-R), or a digital versatile disc (DVD) as a file in an installable format or an executable format and be provided.

The local memory (MEM-C) is used as a copy image buffer or a code buffer. The hard disk (HD) is a storage for use in accumulating image data, font data used for printing, and forms. The hard disk drive (HDD) controls reading/writing of data from or to the HD under the control of the CPU. The network I/F transmits/receives information to or from an external device, such as an information processing device, over a communication network.

The controller 23 operates as a communication control unit that controls bidirectional communication with a host device (e.g., a personal computer), for example, over a communication network.

In addition, the controller 23 operates as an image data processing unit for image data to be transmitted from the host device to the optical writer 22.

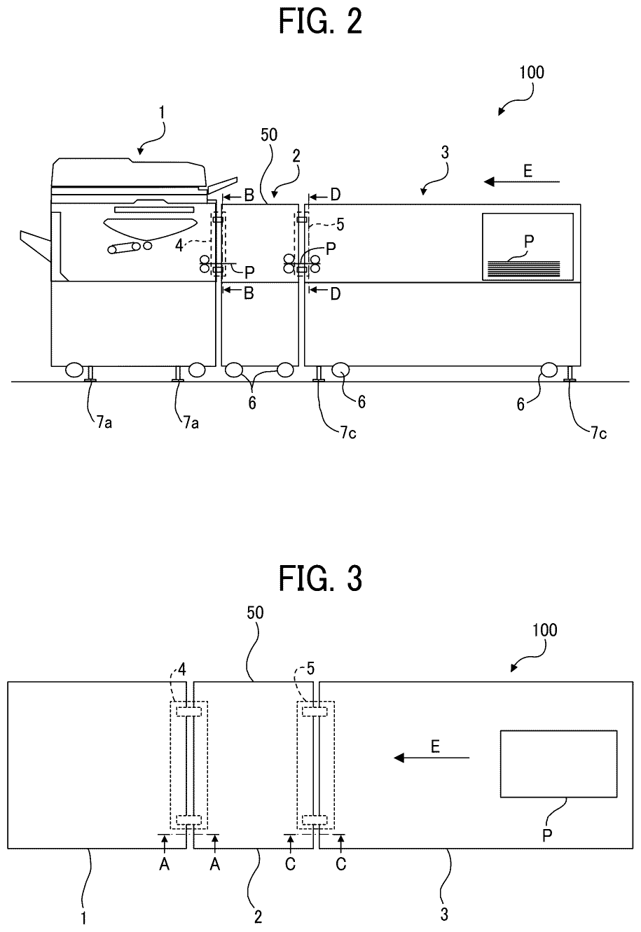

Next, as illustrated in FIG. 2, a configuration of an image forming system 100 will be described, in which a sheet-attitude control apparatus 2 and a sheet feeder 3 are attached to the image forming apparatus 1 as optional units. Then, all of the sheet-attitude control apparatus 2, the sheet feeder 3, and the image forming apparatus 1 are made to function as a single unit.

FIGS. 2 and 3 illustrate a front view and a top view, respectively, of the image forming apparatus 1 from which the manual sheet feeding tray 35 has been removed and to which the sheet-attitude control apparatus 2 and the sheet feeder 3 are coupled.

In this configuration, sheets P are conveyed in a direction indicated by an arrow E in FIG. 2 toward the pickup rollers 341 illustrated in FIG. 1.

The sheet feeder 3 is an optional unit in which a large number of sheets P are to be loaded and held. Also, the sheet feeder 3 is an apparatus that, when performing large-volume printing by using a large number of sheets P that are not accommodated in the sheet storage unit 30, reduces the frequency of resupplying sheets P, thereby improving productivity.

The sheet-attitude control apparatus 2 is an optional unit that controls the attitude of a sheet P discharged from the sheet feeder 3 on the upstream side in the direction E, which is the conveyance direction, and then conveys the sheet P to the image forming apparatus 1. The sheet-attitude control apparatus 2 has a function of controlling the attitude, such as the skew or entry angle, of the sheet P to suppress the sheet jam and image defects.

In this case, configurations of a coupler 4 and a coupler 5 will be described later; the coupler 4 is a coupling part between the image forming apparatus 1 and the sheet-attitude control apparatus 2, whereas the coupler 5 is a coupling part between the sheet-attitude control apparatus 2 and the sheet feeder 3.

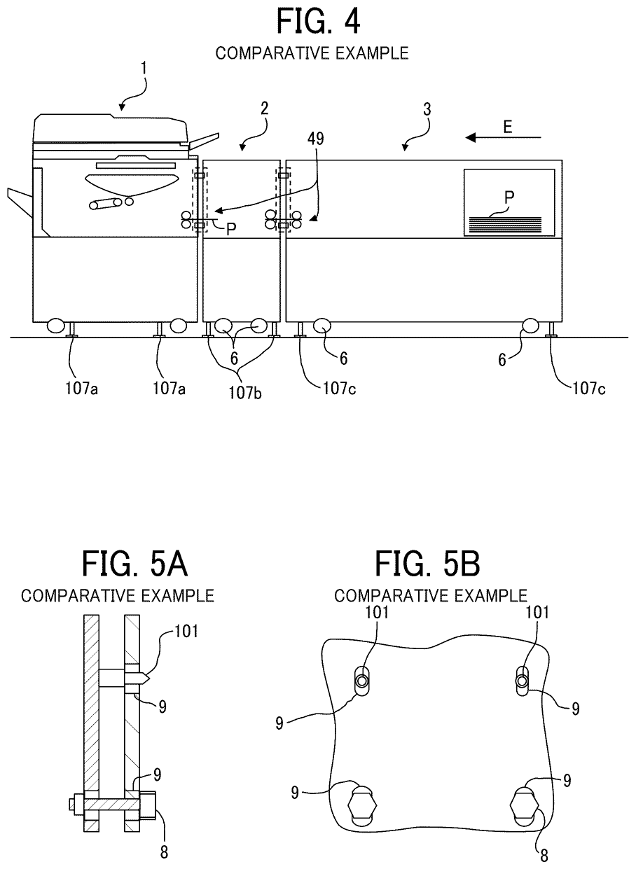

In a conventional, typical securing method, for example, as in a comparative example illustrated in FIG. 4, the heights of conveyance paths in an image forming apparatus 1, a sheet-attitude control apparatus 2, and a sheet feeder 3 are varied by height adjusting members, such as adjuster bolts 107, until the horizontal surfaces of the image forming apparatus 1, the sheet-attitude control apparatus 2, and the sheet feeder 3 have been set to the height at which the heights of the respective conveyance paths become aligned with each other. The adjuster bolts 107a, 107b, and 107c are collectively referred to as the adjuster bolts 107. Then, the image forming apparatus 1, the sheet-attitude control apparatus 2, and the sheet feeder 3 are fastened.

In this case, first, adjuster bolts 107a of the image forming apparatus 1 and adjuster bolts 107b of the sheet-attitude control apparatus 2 are used to align the height of the conveyance path in the image forming apparatus 1 with the height of the conveyance path in the sheet-attitude control apparatus 2, after which the image forming apparatus 1 and the sheet-attitude control apparatus 2 are coupled together by a fastening tool, such as bolts.

Then, to couple the sheet feeder 3 to the sheet-attitude control apparatus 2, the adjuster bolts 107b of the sheet-attitude control apparatus 2 and adjuster bolts 107c of the sheet feeder 3 are used to adjust the heights of the respective conveyance paths so as to become aligned with each other, after which the sheet feeder 3 is coupled to the sheet-attitude control apparatus 2 by a fastening tool, such as securing bolts 8 (see FIGS. 5A and 5B and some other drawings).

As such methods, as illustrated in FIGS. 5A and 5B, a method for using holes 9, each of which is longer in a direction vertical to the installation surface, to adjust the locations of the securing bolts 8, a method for using positioning pins 101 to restrict the moving range in the vertical direction, and some other methods are in practical use.

However, those methods involve adjusting the heights of the adjuster bolts 107 whenever each optional unit is coupled, so that the installation time may be prolonged in proportion to the number of optional units.

Against this backdrop, there is a demand for a method of securing an optional unit, by which the optional unit can be joined to the image forming apparatus 1.

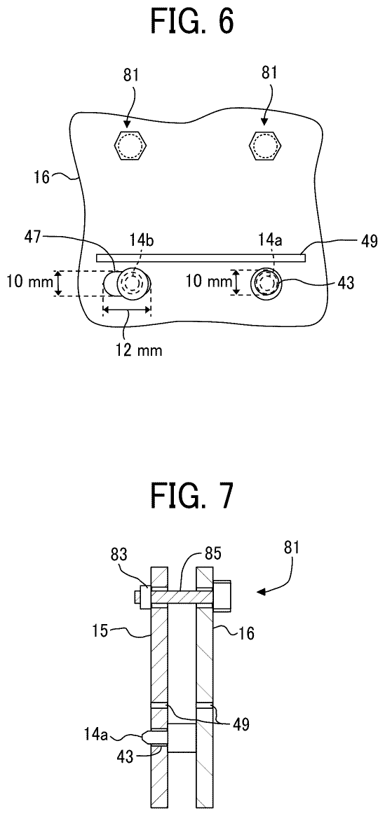

FIGS. 6 and 7 are views of a fastening state of the coupler 4 when the sheet-attitude control apparatus 2, which is a type of optional unit in the present embodiment, is installed on the image forming apparatus 1. FIGS. 6 and 7 correspond, respectively, to the cross section A-A and the cross section B-B illustrated in FIGS. 2 and 3.

In the present embodiment, as illustrated in FIG. 6, two positioning pins 14a and 14b are provided on the sheet-attitude control apparatus 2 side. Further, the positioning pins 14a and 14b are provided to have the same shape on the near side and the far side. Herein, the positioning pin 14a that is formed on the far side in FIG. 2 and interlocks with a first main-engagement hole 43 is referred to as a first main-reference engagement portion, whereas the positioning pin 14b that is formed on the near side and interlocks with the first sub-engagement hole 47 is a first sub-reference engagement portion. However, the first main-reference engagement portion and the first sub-reference engagement portion may be swapped, and the locations of the first main-reference engagement portion and the first sub-reference engagement portion are not limited to such locations.

The sheet-attitude control apparatus 2 includes the first main-engagement hole 43 and the first sub-engagement hole 47 on the surface of the coupler 4 on the side facing the image forming apparatus 1 upon installation. The first main-engagement hole 43 is formed on the image forming apparatus 1 side and is paired with the positioning pin 14a serving as the first main-reference engagement portion to interlock with the positioning pin 14a. The first sub-engagement hole 47 is formed at a height identical to a height of the positioning pin 14a. When the positioning pin 14a interlocks with the first main-engagement hole 43, the positioning pin 14b serving as the first sub-reference engagement portion is fitted into the first sub-engagement hole 47.

The sheet-attitude control apparatus 2 further includes first fastening portions 81 for use in securely coupling the image forming apparatus 1 to the sheet-attitude control apparatus 2 with the positioning pins 14a and 14b being fitted, respectively, into the first main-engagement hole 43 and the first sub-engagement hole 47.

In the present embodiment, each first fastening portion 81 functions as a fastening portion in which nuts 83 and bolts 85 are fastened on the image forming apparatus 1 side as illustrated in FIG. 7, thereby fastening a side plate 16 on the sheet-attitude control apparatus 2 side to a side plate 15 on the image forming apparatus 1 side.

In the present embodiment, each first fastening portion 81 is formed of a bolt and a nut to be fastened; however, each first fastening portion 81 is not limited to this configuration, and any other fixing member may be used instead.

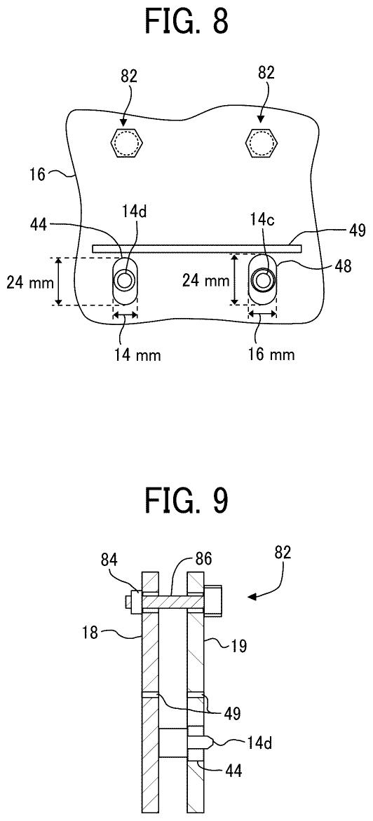

Next, the surface on the coupler 5 side will also be described. FIG. 8 is a view of the surface of the sheet feeder 3 on the side facing the sheet-attitude control apparatus 2 upon installation and on which the coupler 5 is present. FIG. 9 illustrates a cross-sectional view of this surface. Further, FIGS. 8 and 9 correspond, respectively, to the cross section D-D and the cross section C-C illustrated in FIGS. 2 and 3.

The sheet-attitude control apparatus 2 includes a side plate 18 on the side facing the sheet feeder 3 upon installation. The side plate 18 has a positioning pin 14c serving as a second sub-reference engagement portion and a positioning pin 14d serving as a second main-reference engagement portion. The positioning pin 14c is fitted into a second sub-engagement hole 48 on the sheet feeder 3 side. The positioning pin 14d interlocks with a second main-engagement hole 44 formed at a height identical to a height of the second sub-engagement hole 48.

In short, when the positioning pin 14d interlocks with the second main-engagement hole 44, the positioning pin 14c is fitted into the second sub-engagement hole 48 on the sheet feeder 3 side.

The sheet-attitude control apparatus 2 further includes the second fastening portions 82 for use in securely coupling the sheet feeder 3 to the sheet-attitude control apparatus 2 with the sheet feeder 3 being fitted into both the second main-engagement hole 44 and the second sub-engagement hole 48.

Similar to each first fastening portion 81, each second fastening portion 82 functions as a fastening portion in which a nut 84 and a bolt 86 on the sheet-attitude control apparatus 2 side are fastened together, thereby fastening the side plate 18 on the sheet-attitude control apparatus 2 side to the side plate 19 on the sheet feeder 3 side.

In the present embodiment, each second fastening portion 82 is formed of a bolt and a nut to be fastened together; however, each second fastening portion 82 is not limited to this configuration, and any other fixing member may be used instead.

A method for using the first main-engagement hole 43 and the first sub-engagement hole 47 to perform the positioning will be described with reference to FIG. 10.

FIG. 10 illustrates an operation of positioning both the image forming apparatus 1 and the sheet-attitude control apparatus 2 relative to each other, which can be moved separately and independently with casters 6.

When the sheet-attitude control apparatus 2 is attached to the image forming apparatus 1, first, the image forming apparatus 1 is lifted with adjuster bolts 7a and is secured. Then, as illustrated in FIG. 10, the sheet-attitude control apparatus 2 is inclined with the caster 6 on at least one side of the sheet-attitude control apparatus 2 being in contact with the installation surface, after which the positioning pin 14a is fitted into the first main-engagement hole 43.

It should be noted that, as illustrated in FIG. 6, the first main-engagement hole 43 is a circular hole having a diameter of 10 mm, and the first sub-engagement hole 47 is a horizontally-long hole having a height of 10 mm and a width of 12 mm.

Each of the positioning pins 14a and 14b is a cylindrical pin that has a tapered end that has enough size to be fitted into a hole having a diameter of 10 mm.

Thus, when the positioning pin 14b interlocks with the first sub-engagement hole 47, the movement of the side plate 16 is suppressed from moving in the vertical direction, whereas the location of the side plate 16 can be finely adjusted in the horizontal direction within the elongated hole.

Furthermore, when the positioning pin 14a is fitted into the first main-engagement hole 43, which is a circular hole having a diameter of 10 mm as described above, the positioning pin 14b interlocks with the first sub-engagement hole 47 while being fitted into the first sub-engagement hole 47, so that the positioning is performed correctly.

When the positioning pin 14a is fitted into the first main-engagement hole 43, the height at which the positioning pin 14a interlocks with the first main-engagement hole 43 is set within the accessible range of the sheet-attitude control apparatus 2 in an inclined position, namely, below the height of the sheet-attitude control apparatus 2 inclined with at least one of the casters 6 grounded.

With such a configuration, the sheet-attitude control apparatus 2 can be moved horizontally with a caster 6 being in contact with the installation surface. Thus, the sheet-attitude control apparatus 2 can be easily moved in the ±E directions. Therefore, this configuration facilitates the positioning of the positioning pin 14a relative to the first main-engagement hole 43.

In this case, the ratio between a weight M1 of the image forming apparatus 1 and a weight M2 of the sheet-attitude control apparatus 2 preferably satisfies M1>M2, more preferably M1/M2>6. In the present embodiment, M1=260 kg and M2=41 kg.

After the positioning pin 14a has been fitted into the first main-engagement hole 43 and the positioning pin 14b has been fitted into the first sub-engagement hole 47, an operator fastens the nuts 83 and the bolts 85 together to secure the first fastening portions 81, thereby securing the location of the sheet-attitude control apparatus 2 relative to the image forming apparatus 1.

In the present embodiment, as described above, the image forming apparatus 1 is provided so as to be heavier, and the sheet-attitude control apparatus 2 is provided so as to be lighter, under the condition of M1/M2>6.

With such a configuration, even when the image forming apparatus 1 and the sheet-attitude control apparatus 2 are secured by the first fastening portions 81, the center of gravity does not fall outside the casters 6 of the image forming apparatus 1. Thus, even if both casters 6 of the sheet-attitude control apparatus 2 are present at a higher location than a location of the installation surface, the image forming apparatus 1 is less likely to fall down.

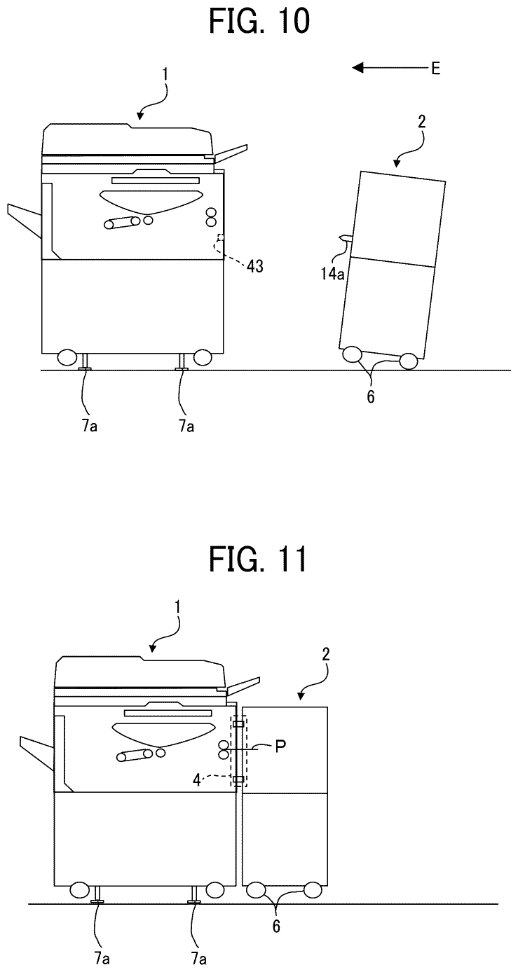

As illustrated in FIG. 11, when the image forming apparatus 1 and the sheet-attitude control apparatus 2 are secured with the first fastening portions 81, the casters 6 of the image forming apparatus 1 and the sheet-attitude control apparatus 2 are kept apart from the installation surface.

When the securing is performed with the first fastening portions 81, both the first main-engagement hole 43 and the first sub-engagement hole 47 are present below, in the vertical direction, a conveyance path 49 along which sheets P are to be conveyed.

With such a configuration, the positioning can be performed at a low place. It is thus possible to narrow the range within which the sheet-attitude control apparatus 2 is moved vertically with the casters 6 floated. Therefore, this configuration contributes to the reduction in efforts for the installation.

Next, a description will be given of an operation of further securing the sheet feeder 3 to the sheet-attitude control apparatus 2 that has been in the state of FIG. 11.

It should be noted that the side plate 18 of the sheet-attitude control apparatus 2 which faces the sheet feeder 3 and the side plate 19 on the sheet feeder 3 side are illustrated in FIGS. 8 and 9 and will not be described accordingly.

As illustrated in FIG. 8, the side plate 19 on the sheet feeder 3 side is provided with the vertically long second main-engagement hole 44 having a length of 24 mm in the vertical direction and a length of 14 mm in the lateral direction and the second sub-engagement hole 48 having a length of 24 mm in the vertical direction and a length of 16 mm in the lateral direction.

Each of the positioning pins 14c and 14d is a cylindrical protrusion having a tip tapered so as to be fitted into a hole having a diameter of 14 mm.

With such a configuration, the positioning pin 14c functions as the second main-reference engagement portion which, while secured to the image forming apparatus 1, pairs up with a member in the sheet feeder 3 to interlock with the surface on the side facing the sheet feeder 3 upon installation.

The positioning pin 14d is formed at a height identical to a height of the second main-reference engagement portion and functions as the second sub-reference engagement portion to be fitted upon the mutual interlocking of the second main-reference engagement portion.

In the present embodiment, the configuration in which the positioning pins 14c and 14d are provided on the sheet-attitude control apparatus 2 side has been described. However, a configuration in which a protrusion is provided on the sheet feeder 3 side and a member to be fitted into this protrusion is provided on the sheet-attitude control apparatus 2 side may be obviously employed.

The positioning pins 14c and 14d may be disposed above the conveyance path 49 as will be described later.

The side plate 19 is provided with the second fastening portions 82 for use in securely coupling the sheet feeder 3 to the sheet-attitude control apparatus 2 with both the second main-reference engagement portion and the second sub-reference engagement portion being fitted into the sheet feeder 3.

In the present embodiment, each second fastening portion 82 functions as a fastening portion in which the bolt 86 and the nut 84 are fastened together, thereby securing the side plate 18 to the side plate 19.

A description will be given of an operation of securing the sheet feeder 3 to the sheet-attitude control apparatus 2 with such a configuration, with reference to FIG. 12.

In the present embodiment, the sheet feeder 3 is a heavy object having a weight M3=230 kg. It is thus difficult to perform an operation of floating the caster 6 on one side with the caster 6 on the other side being in contact with the installation surface.

In the present embodiment, however, the height of the sheet feeder 3 can be varied with adjuster bolts 7c.

Further, the location of the positioning pin 14c, which functions as the second main-reference engagement portion, can be finely adjusted in the vertical direction because the second main-engagement hole 44 is an elongated hole.

Likewise, the positioning pin 14d, which functions as the second sub-reference engagement portion, can be moved not only in the vertical direction but also in the lateral direction because the second sub-engagement hole 48 is formed wider in the lateral direction than the second main-engagement hole 44.

With such a configuration, to attach the sheet feeder 3, the sheet feeder 3 is moved in the horizontal direction with the casters 6, after which the positioning pins 14c and 14d are inserted, respectively, into the second main-engagement hole 44 and the second sub-engagement hole 48.

Then, the height of the sheet feeder 3 is varied with the adjuster bolts 7c, and fine adjustment is performed such that the height of the conveyance path in the sheet feeder 3 becomes aligned with the height of the conveyance path 49 in the sheet-attitude control apparatus 2.

Then, the positioning pins 14c and 14d are fitted into the second main-engagement hole 44 and the second sub-engagement hole 48 and positioned, after which the sheet feeder 3 and the sheet-attitude control apparatus 2 are secured with the second fastening portions 82.

In the above case, the weight M1 of the image forming apparatus 1, the weight M2 of the sheet-attitude control apparatus 2, and the weight M3 of the sheet feeder 3 are set so as to satisfy M1>M3>M2.

With such a configuration, the weight M2 of the sheet-attitude control apparatus 2 is lighter than both the weight M1 of the image forming apparatus 1 and the weight M3 of the sheet feeder 3. Thus, even if the sheet-attitude control apparatus 2 is kept with both casters 6 floated, the influence on the center of gravity is small, and the center of gravity of the entire image forming system is easily stabilized.

It should be noted that due to a considerable weight, the sheet feeder 3 may be difficult to position and couple with one side lifted. Thus, the height is adjusted with the adjuster bolts 7c as a precondition.

In the present embodiment, each of the second main-engagement hole 44 and the second sub-engagement hole 48 is set into a wide shape so as to be larger in size than both the first main-engagement hole 43 and the first sub-engagement hole 47.

With such a configuration, the positioning accuracy when the sheet-attitude control apparatus 2 and the sheet feeder 3 are secured is lower than the positioning accuracy when the image forming apparatus 1 and the sheet-attitude control apparatus 2 are secured. This configuration thus contributes to shortening time to secure the sheet feeder 3 having a heavy weight.

In the present embodiment, when the securing is performed with the second fastening portions 82, as illustrated in FIG. 9, both the second main-engagement hole 44 and the second sub-engagement hole 48 are present below a conveyance path 49 in the vertical direction along which sheets P are to be conveyed.

According to such a configuration, the positioning is performed at a low place. It is thus possible to decrease the range within which the sheet feeder 3 is moved with the adjuster bolts 7c floated. This configuration contributes to the reduction in efforts for the installation.

In the present embodiment, each first fastening portion 81 is located opposite both the first main-engagement hole 43 and the first sub-engagement hole 47 in the vertical direction across the conveyance path 49 for sheets P. Likewise, each second fastening portion 82 is located opposite both the second main-engagement hole 44 and the second sub-engagement hole 48 in the vertical direction across the conveyance path 49 for the sheet P.

According to such a configuration, when the first fastening portions 81 are secured, the first main-reference engagement portion and the first sub-reference engagement portion have been fitted. Thus, the image forming apparatus 1 and the sheet-attitude control apparatus 2 are secured on upper and lower sides in the vertical direction across the conveyance path 49. Therefore, this configuration increases the stability upon attachment.

Likewise, when the second fastening portions 82 are secured, the second main-reference engagement portion and the second sub-reference engagement portion have been fitted. Thus, the sheet feeder 3 and the sheet-attitude control apparatus 2 are fixed on upper and lower sides in the vertical direction across the conveyance path 49. As a result, the stability is high upon attachment.

With such a configuration, the first fastening portions 81 and the second fastening portions 82 are obviously present above the location at which sheets P are to be conveyed.

With the above configuration, when a plurality of optional units is attached to the image forming apparatus 1, the sheet-attitude control apparatus 2 can be moved with one side grounded. After the securing, the bottom surface is kept apart from the installation surfaces of the image forming apparatus 1 and the sheet feeder 3. Therefore, this configuration can shorten the time to install the entire image forming system.

In the above description, the first fastening portions 81 and the second fastening portions 82 are all present above the location at which sheets P are to be conveyed, whereas the first main-reference engagement portion, the first sub-reference engagement portion, the second main-reference engagement portion, and the second sub-reference engagement portion are all present below the location at which sheets P are to be conveyed; however, the present invention is not limited to such a configuration.

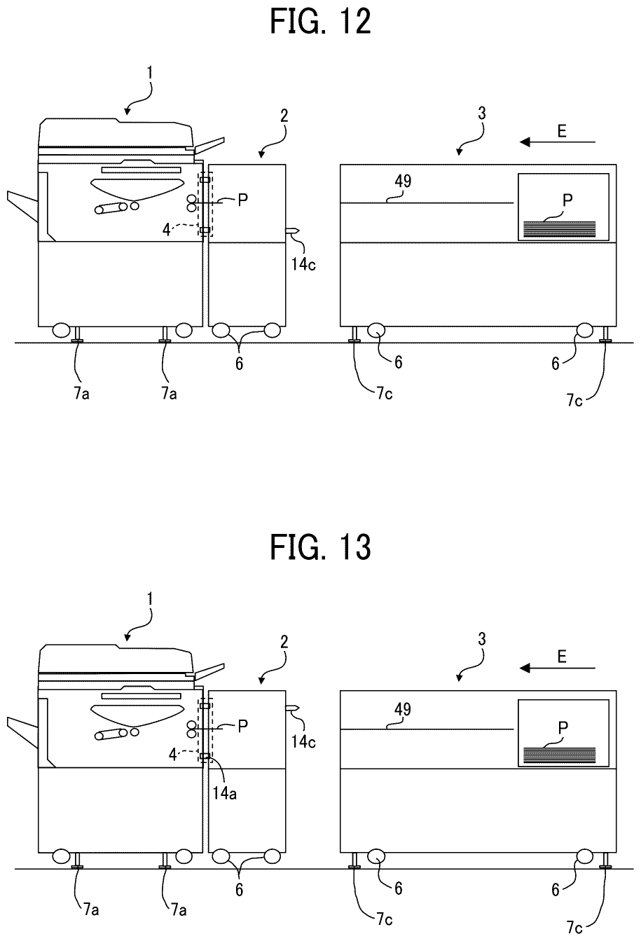

For example, as illustrated in FIG. 13, the positioning pins 14c and 14d may be disposed above the conveyance path 49 for sheets P, and the second main-reference engagement portion and the second sub-reference engagement portion may also be disposed above the conveyance path 49. However, the second fastening portion 82 may be disposed below the conveyance path 49.

Alternatively, both the first main-reference engagement portion and the second main-reference engagement portion may be provided above the conveyance path 49.

In the present embodiment, the positioning pins 14a, 14b, 14c, and 14d are preferably located within the range of ±5 mm in the vertical direction with respect to the conveyance path 49 along which sheets P are to be conveyed to the image forming apparatus 1.

The reason is that, as the conveyance path 49 to be positioned between the sheet-attitude control apparatus 2 and the sheet feeder 3 is located closer to the positioning pins 14a and 14b, which constitute the first main-reference engagement portion and the first sub-reference engagement portion, and the positioning pins 14c and 14d, which constitute the second main-reference engagement portion and the second sub-reference engagement portion, the positioning accuracy may be less subject to deviations.

A sheet-attitude control apparatus (2) includes: a main body (50); a conveyance path (49), passing through the main body (50), along which a sheet (P) is conveyed in a conveyance direction; a first side face of the main body (50) in the conveyance direction, the first side face facing an image forming apparatus to form an image on the sheet fed from the main body (50); a second side face of the main body (50) downstream of the first side face in the conveyance direction, the second side face facing a sheet feeder (3) to load the sheet (P) to be fed to the main body (50); a first engagement portion (4) at the first side face, the first engagement portion (4) having a first pair of pins (14a, 14b) to be respectively inserted into a pair of holes (43, 47) in the image forming apparatus (1), the first pair of pins (14a, 14b) disposed at a first height and at different positions in a width direction perpendicular to the conveyance direction; a first fastening portion (81) at a second height different from the first height to fasten the main body (50) and the image forming apparatus (1); a second engagement portion (5) at the first side face, the second engagement portion (5) having a second-pair of pins (14c, 14d) to be respectively inserted into a pair of holes (44, 48) in the sheet feeder (3), the second pair of pins (14c, 14d) disposed at a third height and at different positions in the width direction; a second fastening portion (82) at a fourth height different from the third height to fasten the main body (50) and the sheet feeder (3); wherein the main body (50) coupled to the image forming apparatus (1) and the sheet feeder (3) has a lowest bottom face spaced apart from an installation surface of the image forming apparatus (1) and the sheet feeder (3).

The sheet-attitude control apparatus has a first weight smaller than each of a second weight of the image forming apparatus and a third weight of the sheet feeder without loading the sheet, and the second weight of the image forming apparatus is larger than the third weight of the sheet feeder. A weight ratio between the second weight of the image forming apparatus and the first weight of the sheet-attitude control apparatus is from 6:1 to 7:1.

The conveyance path controls an inclination of the sheet with respect to the conveyance direction when the sheet is conveyed through the conveyance path. The conveyance path controls an inclination of the sheet with respect to a direction perpendicular to a surface of the sheet when the sheet is conveyed through the conveyance path.

The first pair of pins (14a, 14b) is disposed at the first height below the conveyance path (49), and the second pair of pins (14c, 14d) is disposed at the third height below the conveyance path (49). The first fastening portion (81) is disposed at the second height above the conveyance path (49), and the second fastening portion (82) is disposed at the fourth height above the conveyance path (49).

The first pair of pins (14a, 14b) is disposed at the first height below the conveyance path (49), the second pair of pins (14c, 14d) is disposed at the third height below the conveyance path (49), the first fastening portion (81) is disposed at the second height above the conveyance path (49), and the second fastening portion (82) is disposed at the fourth height above the conveyance path (49). The first pair of pins (14a, 14b) is disposed at the first height within a range of ±5 mm in a vertical direction with respect to the conveyance path (49), and the vertical direction is perpendicular to the conveyance direction and the width direction.

An image forming system includes: the sheet-attitude control apparatus; the image forming apparatus disposed upstream of the sheet-attitude control apparatus in the conveyance direction; and a sheet feeder disposed downstream of the sheet-attitude control apparatus in the conveyance direction, the sheet-attitude control apparatus, the image forming apparatus, and sheet feeder being coupled together, wherein the sheet feeder configured to load the sheet with a first maximum capacity; and the image forming apparatus configured to load the sheet with a second maximum capacity smaller than the first maximum capacity.

The image forming apparatus (1) has the pair of holes (43, 47) into which the first pair of pins (14a, 14b) of the sheet-attitude control apparatus are respectively insertable, and has the pair of holes (43, 47) has: a circular hole (43); and elongated hole (47) elongated in the width direction.

The image forming apparatus (1) has the pair of holes (43, 47) into which the first pair of pins (14a, 14b) of the sheet-attitude control apparatus are respectively insertable, and has the pair of holes (43, 47) having: a circular hole (43); and elongated hole (47) elongated in a vertical direction perpendicular to the conveyance direction and the width direction.

The image forming apparatus (1) includes: a first conveyance path forming a part of the conveyance path; a first caster on a bottom of the image forming apparatus (1); and a first adjuster bolt on a bottom of the image forming apparatus (1) to adjust a height of the image forming apparatus (1); the sheet-attitude control apparatus (2) includes: the conveyance path including a second conveyance path; and a second caster on a bottom face of the main body; and the sheet feeder (3) includes: a third conveyance path forming a part of the conveyance path; a third caster on a bottom of the image forming apparatus (1); and a second adjuster bolt on a bottom of the sheet feeder (3) to adjust a height of the sheet feeder (3), wherein the sheet-attitude control apparatus (2) does not include an adjuster bolt, and the main body (5) of the sheet-attitude control apparatus (2) coupled to the image forming apparatus (1) and the sheet feeder (3), a height of each of which are respectively adjusted by the first adjuster bolt and the second adjuster bolt, has: the conveyance path including the first conveyance path, the second conveyance path, and the third conveyance path disposed at a same height; and the lowest bottom face as a bottom face of the second caster is spaced apart from the installation surface.

Aspects of the present embodiment are, for example, as follows.

### Aspect 1

According to Aspect 1, a sheet-attitude control apparatus includes: a first main-reference engagement portion that pairs up with a member on an image forming apparatus side to interlock a surface on a side facing the image forming apparatus upon installation; a first sub-reference engagement portion formed at a height identical to a height of the first main-reference engagement portion, the first sub-reference engagement portion into which the first main-reference engagement portion is fitted at a time of mutual interlocking of the first main-reference engagement portion; a first fastening portion for use in securely coupling the image forming apparatus and the sheet-attitude control apparatus with both the first main-reference engagement portion and the first sub-reference engagement portion being fitted into the image forming apparatus; a second main-reference engagement portion that pairs up with a member in the sheet feeder to interlock with a surface on a side facing the sheet feeder upon installation in a state of being secured to the image forming apparatus; a second sub-reference engagement portion formed at a height identical to a height of the second main-reference engagement portion, the second sub-reference engagement portion into which the second main-reference engagement portion is fitted at a time of mutual interlocking of the second main-reference engagement portion; and a second fastening portion for use in securely coupling the sheet feeder and the sheet-attitude control apparatus with both the second main-reference engagement portion and the second sub-reference engagement portion being fitted into the sheet feeder. While the image forming apparatus, the sheet-attitude control apparatus, and the sheet feeder are secured to one another, the sheet-attitude control apparatus is kept with a bottom surface of the sheet-attitude control apparatus being apart from installation surfaces of the image forming apparatus and the sheet feeder.

According to such a configuration, when a plurality of optional units are attached to the image forming apparatus 1, the sheet-attitude control apparatus 2 can be moved with one side grounded. In addition, after the securing, the sheet-attitude control apparatus 2 is kept with a bottom surface of the sheet-attitude control apparatus 2 being apart from the installation surfaces of the image forming apparatus 1 and the sheet feeder 3. Therefore, this configuration can shorten the time to install the entire image forming system.

### Aspect 2

According to Aspect 2, in the sheet-attitude control apparatus of Aspect 1, weights of the image forming apparatus, the sheet-attitude control apparatus, and the sheet feeder in which no sheets are loaded satisfy a relationship: the image forming apparatus>the sheet feeder>the sheet-attitude control apparatus.

With such a configuration, the weight M2 of the sheet-attitude control apparatus 2 is lighter than both the weight M1 of the image forming apparatus 1 and the weight M3 of the sheet feeder 3. Thus, even if the sheet-attitude control apparatus 2 is kept with both casters 6 floated, the influence on the center of gravity is small, and the center of gravity of the entire image forming system is easily stabilized.

### Aspect 3

According to Aspect 3, in the sheet-attitude control apparatus of Aspect 1 or 2, a weight ratio between the image forming apparatus and the sheet-attitude control apparatus is from 6:1 to 7:1.

According to such a configuration, the weight of the sheet-attitude control apparatus 2 is sufficiently light relative to the weight of the image forming apparatus 1, so that the center of gravity is biased toward the image forming apparatus 1. Therefore, when the image forming apparatus 1 and the sheet-attitude control apparatus 2 are secured by the first fastening portions 81, even if the casters 6 of the sheet-attitude control apparatus 2 which are present at a higher location than the location of the installation surface are floated, the image forming apparatus 1 is less likely to fall down.

### Aspect 4

According to Aspect 4, in the sheet-attitude control apparatus of any one of Aspects 1 to 3, the sheet-attitude control apparatus has a function of controlling an attitude of the sheet passing through the sheet-attitude control apparatus.

According to such a configuration, it is possible to control the attitude, such as the skew or entry angle, of the sheet P being conveyed from the sheet feeder 3 toward the image forming apparatus 1. Therefore, this configuration can suppress the sheet jam and image defects.

### Aspect 5

According to Aspect 5, in the sheet-attitude control apparatus of any one of Aspects 1 to 4, the sheet-attitude control apparatus has a function of controlling, during conveying of the sheet, an angle of the sheet in a direction orthogonal to a surface of the sheet.

According to such a configuration, it is possible to control the attitude, such as the skew or entry angle, of the sheet P being conveyed from the sheet feeder 3 toward the image forming apparatus 1. Therefore, this configuration can suppress the sheet jam and image defects.

### Aspect 6

According to Aspect 6, in the sheet-attitude control apparatus of any one of Aspects 1 to 5, all the first main-reference engagement portion, the first sub-reference engagement portion, the second main-reference engagement portion, and the second sub-reference engagement portion are present below, in a vertical direction, a location at which the sheet is to be conveyed.

With such a configuration, the positioning can be performed at low places. It is thus possible to narrow the range within which the sheet-attitude control apparatus 2 is moved vertically with the casters 6 floated. Therefore, this configuration contributes to the reduction in efforts for the installation.

### Aspect 7

According to Aspect 7, in the sheet-attitude control apparatus of any one of Aspects 1 to 6, both the first fastening portion and the second fastening portion are present above a location at which the sheet is to be conveyed.

With such configuration, the positioning is performed at high places. It is thus possible to avoid a place around the conveyance path 49 where many obstacles are present, during a securing process. Therefore, this configuration improves operator's workability, thereby contributing to the reduction in efforts for the installation.

### Aspect 8

According to Aspect 8, in the sheet-attitude control apparatus of any one of Aspects 1 to 7, both the first main-reference engagement portion and the first sub-reference engagement portion are located opposite the first fastening portion across a location at which the sheet is to be conveyed. In addition, both the second main-reference engagement portion and the second sub-reference engagement portion are located opposite the second fastening portion across the location at which the sheet is to be conveyed.

According to such a configuration, the positioning is performed at different locations on both sides of the sheet-attitude control apparatus. In addition, the first fastening portion 81 and the second fastening portion 82 are located opposite each other across the conveyance path 49. Therefore, this configuration can reliably secure the sheet-attitude control apparatus 2.

According to Aspect 9, in the sheet-attitude control apparatus of any one of Aspects 1 to 8, both the first main-reference engagement portion and the first sub-reference engagement portion are located within a range of ±5 mm in a vertical direction with respect to a location at which the sheet is to be conveyed to the image forming apparatus.

With such a configuration, the reference positioning is performed at a location close to the conveyance path 49 for the sheet P. Therefore, this configuration makes the location of the conveyance path 49 less likely to be displaced, thereby easily keeping the attitude of the sheet P.

### Aspect 10

According to Aspect 10, an image forming system includes: the sheet-attitude control apparatus of any one of Aspects 1 to 9; an image forming apparatus disposed upstream of the sheet-attitude control apparatus; and a sheet feeder disposed downstream of the sheet-attitude control apparatus, the sheet-attitude control apparatus, the image forming apparatus, and sheet feeder being coupled together. A maximum capacity of the sheet feeder to load the sheet is larger than a maximum capacity of the image forming apparatus to load the sheet.

With this configuration, a sufficiently larger number of sheets P can be loaded in sheet feeder 3 than in the storage unit 30 of the image forming apparatus 1. Therefore, this configuration can reduce the necessity to resupply sheets P during the operation of the image forming apparatus 1, thereby allowing the apparatuses to work for a long time.

According to the present embodiment, when an optional unit is coupled to the image forming apparatus and is positioned, it is unnecessary to lift up the image forming apparatus from the floor surface.

Some embodiments have been described above; however, the present embodiment is not limited to such particular embodiments. Unless otherwise particularly limited in the above description, various modifications and alterations may be made without departing from the scope of the spirit of the present embodiment in the claims.

The effects in the present embodiment correspond to examples of the most favorable effects derived from the present embodiment. Thus, the effects of the present embodiment are not limited to the effects in the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A sheet-attitude control apparatus comprising:
a main body;
a conveyance path, passing through the main body, along which a sheet is conveyed in a conveyance direction;
a first side face of the main body in the conveyance direction,
the first side face facing an image forming apparatus to form an image on the sheet fed from the main body;
a second side face of the main body downstream of the first side face in the conveyance direction,
the second side face facing a sheet feeder to load the sheet to be fed to the main body;
a first engagement portion at the first side face,
the first engagement portion having a first pair of pins to be respectively inserted into a pair of holes in the image forming apparatus,
a first pair of pins disposed at a first height and at different positions in a width direction perpendicular to the conveyance direction;
a first fastening portion at a second height different from the first height to fasten the main body and the image forming apparatus;
a second engagement portion at the first side face,
the second engagement portion having a second-pair of pins to be respectively inserted into a pair of holes in the sheet feeder,
a second pair of pins disposed at a third height and at different positions in the width direction; and
a second fastening portion at a fourth height different from the third height to fasten the main body and the sheet feeder,
wherein the main body coupled to the image forming apparatus and the sheet feeder has a lowest bottom face spaced apart from an installation surface of the image forming apparatus and the sheet feeder.

2. The sheet-attitude control apparatus according to claim 1,
wherein the sheet-attitude control apparatus has a first weight smaller than each of a second weight of the image forming apparatus and a third weight of the sheet feeder without loading the sheet, and
the second weight of the image forming apparatus is larger than the third weight of the sheet feeder.

3. The sheet-attitude control apparatus according to claim 2,
wherein a weight ratio between the second weight of the image forming apparatus and the first weight of the sheet-attitude control apparatus is from 6:1 to 7:1.

4. The sheet-attitude control apparatus according to claim 1,
wherein the conveyance path controls an inclination of the sheet with respect to the conveyance direction when the sheet is conveyed through the conveyance path.

5. The sheet-attitude control apparatus according to claim 1,
wherein the conveyance path controls an inclination of the sheet with respect to a direction perpendicular to a surface of the sheet when the sheet is conveyed through the conveyance path.

6. The sheet-attitude control apparatus according to claim 1,
wherein the first pair of pins is disposed at the first height below the conveyance path, and
the second pair of pins is disposed at the third height below the conveyance path.

7. The sheet-attitude control apparatus according to claim 1,
wherein the first fastening portion is disposed at the second height above the conveyance path, and
the second fastening portion is disposed at the fourth height above the conveyance path.

8. The sheet-attitude control apparatus according to claim 1,
wherein the first pair of pins is disposed at the first height below the conveyance path,
the second pair of pins is disposed at the third height below the conveyance path,
the first fastening portion is disposed at the second height above the conveyance path, and
the second fastening portion is disposed at the fourth height above the conveyance path.

9. The sheet-attitude control apparatus according to claim 1,
wherein the first pair of pins is disposed at the first height within a range of ±5 mm in a vertical direction with respect to the conveyance path, and
the vertical direction is perpendicular to the conveyance direction and the width direction.

10. An image forming system comprising:
the sheet-attitude control apparatus according to claim 1;
the image forming apparatus disposed upstream of the sheet-attitude control apparatus in the conveyance direction; and
a sheet feeder disposed downstream of the sheet-attitude control apparatus in the conveyance direction,
the sheet-attitude control apparatus, the image forming apparatus, and sheet feeder being coupled together,
wherein the sheet feeder configured to load the sheet with a first maximum capacity; and
the image forming apparatus configured to load the sheet with a second maximum capacity smaller than the first maximum capacity.

11. The image forming system according to claim 10,
wherein the image forming apparatus has the pair of holes into which the first pair of pins of the sheet-attitude control apparatus are respectively insertable, and
the pair of holes has:
a circular hole; and
elongated hole elongated in the width direction.

12. The image forming system according to claim 10,
wherein the image forming apparatus has the pair of holes into which the first pair of pins of the sheet-attitude control apparatus are respectively insertable, and
the pair of holes has:
a circular hole; and
elongated hole elongated in a vertical direction perpendicular to the conveyance direction and the width direction.

13. The image forming system according to claim 10,
wherein the image forming apparatus includes:
a first conveyance path forming a part of the conveyance path;
a first caster on a bottom of the image forming apparatus; and
a first adjuster bolt on a bottom of the image forming apparatus to adjust a height of the image forming apparatus;
the sheet-attitude control apparatus includes:
the conveyance path including a second conveyance path; and
a second caster on a bottom face of the main body; and
the sheet feeder includes:
a third conveyance path forming a part of the conveyance path;
a third caster on a bottom of the image forming apparatus; and
a second adjuster bolt on a bottom of the sheet feeder to adjust a height of the sheet feeder,
wherein the sheet-attitude control apparatus does not include an adjuster bolt, and
the main body of the sheet-attitude control apparatus coupled to the image forming apparatus and the sheet feeder, a height of each of which are respectively adjusted by the first adjuster bolt and the second adjuster bolt, has:
the conveyance path including the first conveyance path, the second conveyance path, and the third conveyance path disposed at a same height; and
the lowest bottom face as a bottom face of the second caster is spaced apart from the installation surface.
